(19) United States
(12) Patent Application Publication
(10) Pub. No.: US 2026/0316000 A1
(43) Pub. Date: Oct. 15, 2026

(54) CO2 CAPTURE METHOD

(71) Applicant: TOYOTA JIDOSHA KABUSHIKI KAISHA, Toyota-shi (JP)

(72) Inventor: Masaki WATANABE, Sunto-gun (JP)

(73) Assignee: TOYOTA JIDOSHA KABUSHIKI KAISHA, Toyota-shi (JP)

(21) Appl. No.: 19/465,222

(22) Filed: Jan. 30, 2026

(30) Foreign Application Priority Data
Apr. 4, 2025 (JP) 2025-062175

(51) Int. Cl. B01D 53/62; B01D 53/82; B01D 53/96; B01J 20/26; B01J 20/28; B01J 20/32; B01J 20/34; C01B 32/50

(52) U.S. Cl. CPC B01D 53/62; B01D 53/82; B01D 53/96; B01J 20/262; B01J 20/28045; B01J 20/3204; B01J 20/3272; B01J 20/3425; B01J 20/3483; C01B 32/50; B01D 2253/202; B01D 2253/3425; B01D 2257/504; B01D 2258/06; B01D 2259/40088

(57) ABSTRACT

In a CO₂ capture method according to the present disclosure, CO₂ contained in a supplied gas is adsorbed onto a CO₂ adsorbent body, and the CO₂ adsorbed on the CO₂ adsorbent body is recovered by desorbing the CO₂ from the CO₂ adsorbent body through adjustment of the CO₂ adsorbent body to a temperature higher than a temperature during adsorption of CO₂, adsorption and desorption of CO₂ being alternately repeated. In the CO₂ capture method, t1 represents the shortest time for the CO₂ adsorption ratio of the CO₂ adsorbent body to reach 80 vol % or more, t2 represents the cycle time including the adsorption and desorption of CO₂, and t1<t2<4×t1 is satisfied.

### CROSS-REFERENCE TO RELATED APPLICATION

This application claims priority to Japanese Patent Application No. 2025-062175 filed on Apr. 4, 2025. The disclosure of the above-identified application, including the specification, drawings, and claims, is incorporated by reference herein in its entirety.

### BACKGROUND

### 1. Technical Field

The present disclosure relates to CO₂ capture methods.

### 2. Description of Related Art

CO₂ capture methods for capturing carbon dioxide (CO₂) from the atmosphere are under active development. For example, a CO₂ method is known in which air is passed through a direct air capture device at room temperature such that CO₂ is adsorbed, followed by heating the device to around 100° C. to cause the CO₂ to desorb for recovery (for example, Japanese Unexamined Patent Application Publication No. 2024-154557 (JP 2024-154557 A)).

### SUMMARY

However, the method disclosed in JP 2024-154557 A involves high costs when capturing CO₂ from the atmosphere, and further cost reductions have been desired.

The present disclosure has been made in view of the above circumstances, and an object thereof is to provide a CO₂ capture method capable of capturing CO₂ efficiently and at low cost.

In a CO₂ capture method according to the present disclosure, CO₂ contained in a gas that is supplied is adsorbed onto a CO₂ adsorbent body, and the CO₂ adsorbed on the CO₂ adsorbent body is recovered by desorbing the CO₂ from the CO₂ adsorbent body through adjustment of the CO₂ adsorbent body to a temperature higher than a temperature during adsorption of CO₂, adsorption and desorption of CO₂ being alternately repeated. In the CO₂ capture method, t1 represents the shortest time for an CO₂ adsorption ratio of the CO₂ adsorbent body to reach 80 vol % or more, t2 represents a cycle time including the adsorption and desorption of CO₂, and t1<t2<4×t1 is satisfied.

As described above, the CO₂ capture method according to the present disclosure performs CO₂ capture in a shorter cycle time than typical CO₂ capture methods in which adsorption is carried out until the CO₂ adsorption ratio of the CO₂ adsorbent body reaches 100 vol %, that is, methods that make full use of the adsorption capacity of the CO₂ adsorbent body. In this manner, in the method of the present disclosure that performs CO₂ capture in a shorter cycle time than typical CO₂ capture methods, a comprehensive evaluation of the CO₂ capture amount and various costs associated with CO₂ capture shows that the CO₂ capture cost can be reduced and that CO₂ can be captured efficiently, compared with typical CO₂ capture methods.

The CO₂ adsorbent body may include a CO₂ adsorbent and a plurality of porous supports that carries the CO₂ adsorbent, and the CO₂ adsorbent may include polyethyleneimine having an isopropyl group.

The porous supports may have a honeycomb structure.

The rate at which the gas is supplied to the CO₂ adsorbent body may be 11 m/s or more.

The porous supports may be coated with silica gel, and the thickness of the silica gel may be 250 μm or less.

The present disclosure can provide a CO₂ capture method capable of capturing CO₂ efficiently and at low cost.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of the configuration of a CO₂ capture device that can be used in the CO₂ capture method of the present disclosure;

FIG. 2 is a table illustrating the operation of the CO₂ capture device in the CO₂ capture method of the present disclosure;

FIG. 3 is a graph showing an example of the relationship between the adsorption ratio of a CO₂ adsorbent body (CO₂ adsorbent) and the thickness of a silica-gel coating applied to porous supports; and

FIG. 4 is a graph showing an example of the relationship between cycle time and cost ratio in the CO₂ capture method of the present disclosure.

### DETAILED DESCRIPTION OF EMBODIMENTS

An embodiment of the disclosure will be described below. However, the disclosure defined by the claims is not limited to the following embodiment. It is not necessarily the case that all of the components described in the embodiment are needed to achieve the objectives of the disclosure. For the sake of clarity, certain descriptions and drawings are omitted or simplified as appropriate.

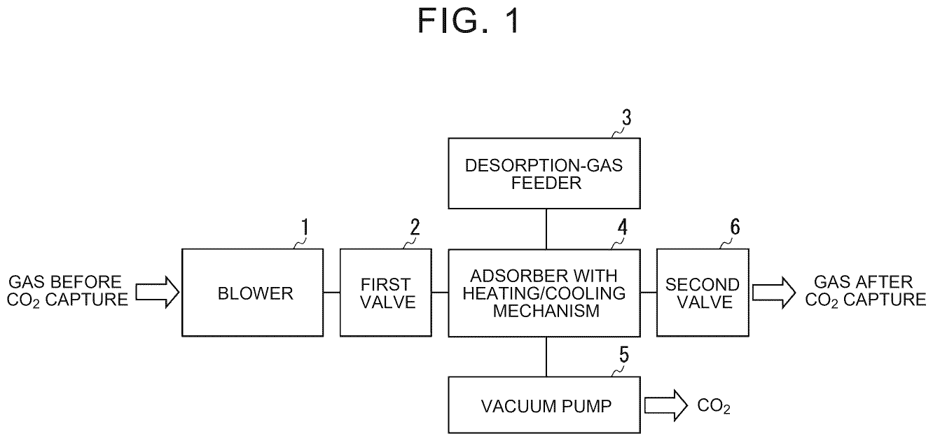

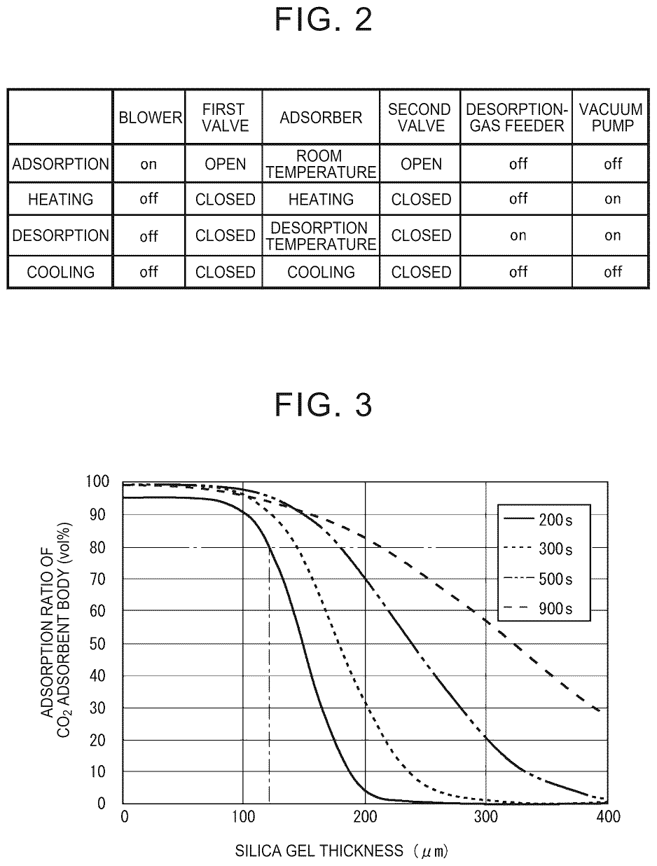

In the CO₂ capture method according to the present disclosure (hereinafter also simply referred to as the “present method”), CO₂ contained in a gas supplied from outside is adsorbed onto a CO₂ adsorbent body. The CO₂ adsorbed on the CO₂ adsorbent body is recovered by desorbing the CO₂ from the CO₂ adsorbent body through adjustment of the CO₂ adsorbent body to a temperature higher than a temperature during adsorption of CO₂. Such adsorption and desorption of CO₂ are alternately repeated. In the present method, t1 represents the shortest time for the CO₂ adsorption ratio of the CO₂ adsorbent body to reach 80 vol % or more, and t2 represents the cycle time including the adsorption and desorption of CO₂, and the relationship of Expression (1), t1<t2<4×t1, is satisfied. By setting the cycle time t2 so as to satisfy Expression (1), costs including electricity cost can be further reduced. FIG. 1 shows an example of the configuration of a CO₂ capture device that can be used in the CO₂ capture method of the present disclosure. FIG. 2 is a table illustrating the operation of the CO₂ capture device.

The CO₂ capture device shown in FIG. 1 is a device that captures CO₂ by alternately performing a CO₂ adsorption step and a CO₂ desorption step. The CO₂ capture device includes a blower 1, a first valve 2, a desorption-gas feeder 3, an adsorber 4 equipped with a heating/cooling mechanism, a vacuum pump 5, and a second valve 6.

More specifically, as shown in FIG. 2, the blower 1 is turned on such that gas supplied from outside, i.e., gas before CO₂ capture (such as exhaust gas or ambient air), is introduced into the adsorber 4 equipped with the heating/cooling mechanism through the open first valve 2. The gas may be exhaust gas from a factory or power plant having a relatively high CO₂ concentration, or may be ambient air with a relatively low CO₂ concentration.

CO₂ contained in the gas is adsorbed onto a CO₂ adsorbent body inside the adsorber 4 at room temperature (e.g., 25° C.). The gas after CO₂ capture, i.e., the gas from which part of the CO₂ has been removed by the CO₂ adsorbent body, is discharged to the outside through the open second valve 6.

After the adsorption step is performed for, for example, five minutes or less, the CO₂ desorption step is performed. Specifically, the adsorber 4 is first evacuated using the vacuum pump 5, followed by operations such as oxygen purging and heating using the heating mechanism. As a result, in the CO₂ desorption step, the temperature of the adsorber 4 (i.e., the CO₂ adsorbent body) is adjusted to a higher temperature (gas desorption temperature) than that used in the CO₂ adsorption step. In the CO₂ desorption step, the pressure inside the adsorber 4 may also be adjusted to a lower level than in the CO₂ adsorption step, or the CO₂ partial pressure inside the adsorber 4 may be reduced by introducing a gas such as steam into the adsorber 4. These adjustments cause the CO₂ that has been adsorbed on the CO₂ adsorbent body to begin to desorb. During this operation, with the desorption-gas feeder 3 and the vacuum pump 5 turned on, the CO₂ adsorbed on the CO₂ adsorbent body is made to desorb from the CO₂ adsorbent body and is recovered. In the case where the CO₂ capture process is to be continued, the adsorber 4 is cooled by the cooling mechanism, and the gas before CO₂ capture is introduced again into the adsorber 4 for adsorption, thereby continuing the CO₂ capture process.

The CO₂ capture device may have a multi-unit configuration in which multiple first valves 2, multiple adsorbers 4, and multiple second valves 6 are provided, with the blower 1, the desorption-gas feeder 3, and the vacuum pump 5 being shared among them. In such a CO₂ capture device, since the blower 1, the desorption-gas feeder 3, and the vacuum pump 5 are shared among the units, it is preferable to control the device such that the operations shown in FIG. 2 for each unit configured by a first valve 2, an adsorber 4, and a second valve 6 do not overlap.

The CO₂ capture device may also include a temperature controller that adjusts the temperature of the adsorber 4, a pressure controller that adjusts the pressure inside the adsorber 4, and a humidity controller that adjusts the humidity inside the adsorber 4.

The CO₂ capture device may further include a control unit that performs control to alternately repeat the CO₂ adsorption step and the CO₂ desorption step. This control unit may also set the respective operating conditions (such as temperature, pressure, and humidity) for the CO₂ adsorption step and the CO₂ desorption step.

Since the present method can repeat the cycle in a shorter period of time than typical CO₂ capture methods, the CO₂ capture device can be made smaller in size than typical CO₂ capture devices.

In addition, in the present method, the CO₂ desorption step can be performed at a lower temperature (e.g., at 60° C. or less) than in typical CO₂ capture methods. For example, when the adsorption step is performed for five minutes and the desorption step is performed for five minutes, which constitute a 10-minute cycle, and the desorption temperature is set to 60° C., an amount of CO₂ recovery comparable to that obtained under a typical high-temperature condition (e.g., 80° C. or more) in a 10-minute cycle can be achieved. Thus, low-temperature desorption and high-speed cycling enables further reduction in cost.

In the present method, CO₂ can be recovered by repeatedly operating the CO₂ capture device in such a manner that the four operations in the adsorber, i.e., adsorption, heating, desorption, and cooling, constitute one cycle, and by alternately repeating the CO₂ adsorption step (cooling and adsorption operations) and the CO₂ desorption step (heating and desorption operations). In this case, as described above, the operation times of the four operations are set such that the cycle time t2 satisfies Expression (1): t1<t2<4×t1, where t1 represents the shortest time it takes for the CO₂ adsorption ratio of the CO₂ adsorbent body to reach 80 vol % or more. As long as Expression (1) is satisfied, the respective operation times of the operations are not particularly limited. For example, the CO₂ adsorption step (cooling and adsorption operations) may be set to a time of t1/2 or more and less than 2×t1, and the CO₂ desorption step (heating and desorption operations) may also be set to a time of t1/2 or more and less than 2×t1.

The desorption temperature can be set as appropriate by heating, and may be, for example, 90° C. or less, 85° C. or less, 80° C. or less, 75° C. or less, or 70° C. or less. The adsorption temperature can be set as appropriate by cooling, and may be 20° C. or more, 25° C. or more, 30° C. or more, 35° C. or more, or 40° C. or more.

Here, t1 represents the shortest time it takes for the CO₂ adsorption capacity of the adsorber 4 used (more specifically, the CO₂ adsorbent body) to reach 80 vol % or more, where the adsorption capacity obtained when CO₂ is allowed to be adsorbed for a sufficiently long time (e.g., one hour or more), that is, when the adsorption capacity of the adsorber 4 is fully utilized, is defined as 100 vol %. In other words, t1 can be regarded as the adsorption time for the CO₂ adsorption capacity of the adsorber 4 reaches 80 vol %.

The value of t1 can be set as appropriate depending on the CO₂ capture device used (more specifically, depending on the CO₂ adsorbent body used). For example, t1 may be five minutes or less, four minutes 30 seconds or less, four minutes or less, three minutes 30 seconds or less, three minutes or less, two minutes 30 seconds or less, or two minutes or less. When t1 is five minutes or less, cost reduction can be more easily achieved.

From a cost perspective, t1 is defined as the shortest time it takes for the CO₂ adsorption ratio of the CO₂ adsorbent body used to reach 80 vol % or more. However, the CO₂ adsorption ratio at t1 may be set to 75 vol % or more, 81 vol % or more, 82 vol % or more, 83 vol % or more, 84 vol % or more, or 85 vol % or more. However, from the viewpoint of minimizing costs, it is preferable that the CO₂ adsorption ratio at t1 be 80 vol % or more.

In addition, t2 represents the cycle time including adsorption and desorption of CO₂, and can be set as appropriate depending on the adsorber used, within the range that satisfies the above Expression (1). For example, t2 may be less than 60 minutes, 55 minutes or less, 50 minutes or less, 45 minutes or less, 40 minutes or less, 35 minutes or less, 30 minutes or less, 25 minutes or less, or 20 minutes or less.

The lower limit of t2 can also be set as appropriate depending on the adsorber used, within the range that satisfies the above Expression (1). For example, t2 may satisfy t2≥1.1×t1, t2≥1.2×t1, t2≥1.3×t1, t2≥1.4×t1, or t2≥1.5×t1. When the lower limit value of t2 satisfies the above Expression (1), CO₂ desorption and CO₂ adsorption can be performed sufficiently. For example, t2 may be four minutes or more, four minutes 30 seconds or more, or five minutes or more.

In the present method, it is also preferable that the rate at which the gas is supplied from outside to the adsorber 4 (CO₂ adsorbent body) be 11 m/s or more. In other words, it is preferable that the gas velocity provided by the blower 1 in the CO₂ capture device be 11 m/s or more. By setting the supply rate to the adsorber to 11 m/s or more and thereby increasing the adsorption rate, the time t1 can be shortened, making it easier to achieve cost reduction. The upper limit of the supply rate may be set as appropriate within a range that allows the effects of the present disclosure to be achieved, and is not particularly limited. The supply rate may be less than 11 m/s.

The individual components constituting the CO₂ capture device are not particularly limited and may be any conventionally known components, as long as the effects of the present disclosure can be achieved. Accordingly, the following description focuses on those portions of the present method that are of particular interest, and descriptions of other configurations will be omitted.

The CO₂ adsorbent body may include a CO₂ adsorbent capable of adsorbing CO₂ and a plurality of porous supports that carries the CO₂ adsorbent. The adsorber 4 containing the CO₂ adsorbent body used in the present method is preferably one that can achieve a CO₂ adsorption ratio of 80 vol % or more for the CO₂ adsorbent body even with a short cycle time (e.g., a cycle time of four minutes or more and less than 60 minutes).

It is preferable that the porous supports have a honeycomb structure. The porous supports having a honeycomb structure make it possible to easily suppress pressure loss and a drop in gas velocity during CO₂ capture. Accordingly, the time t1 can be shortened, and cost reduction can be easily achieved.

For example, the porous supports may be formed by coating a honeycomb-shaped substrate with a porous material that contains silica gel or alumina as a main component and has multiple pores with an average pore diameter of 2 nm to 200 nm. It is preferable that the porous supports be coated with silica gel or alumina (particularly silica gel).

FIG. 3 is a graph showing an example of the relationship between the adsorption ratio of the CO₂ adsorbent body (CO₂ adsorbent) and the thickness of the silica-gel coating applied to the porous supports. The adsorption ratio of the CO₂ adsorbent body indicates the value (adsorption capacity) expressed as a percentage, with the adsorption capacity after the CO₂ adsorbent body has adsorbed CO₂ for a sufficiently long time (e.g., one hour or more) defined as 100 vol %. FIG. 3 shows the relationship between the thickness of the silica-gel coating for four cases in which the CO₂ adsorption time for the CO₂ adsorbent body is set to 200 seconds, 300 seconds, 500 seconds, and 900 seconds, and the adsorption ratio of the CO₂ adsorbent body (the same CO₂ adsorbent body in all cases).

As shown in FIG. 3, the thinner the coating layer becomes, the shorter the time it takes for CO₂ to diffuse from the surface of the CO₂ adsorbent body into its interior, resulting in faster CO₂ adsorption onto the CO₂ adsorbent and a higher adsorption ratio. The thickness of the silica-gel coating layer may be, for example, 250 μm or less, 220 μm or less, 200 μm or less, 180 μm or less, 150 μm or less, 120 μm or less, or 100 μm or less. For example, in the example shown in FIG. 3, when the adsorption time is 200 seconds, the adsorption ratio of the CO₂ adsorbent body can be 80 vol % or more when the thickness of the silica gel (coating layer) is 120 μm or less.

The CO₂ adsorbent is not particularly limited, and may be, for example, a polyamine containing any of polyethyleneimine, methylated polyethyleneimine, isopropylated polyethyleneimine, polyallylamine, pentaethylenehexamine, methylated pentaethylenehexamine, isopropylated pentaethylenehexamine, tetraethylenepentamine, methylated tetraethylenepentamine, or isopropylated tetraethylenepentamine, or an amino-group-containing compound containing a polyamine.

Among these, the CO₂ adsorbent preferably contains polyethyleneimine having an isopropyl group, because it provides excellent cycle durability.

Various costs associated with CO₂ capture (i.e., the CO₂ capture cost, which is the cost to capture 1 kg of CO₂) can be considered, for example, in the two categories described below. Whether cost reduction has been achieved is determined comprehensively in view of these costs together with the amount of CO₂ captured (see JST (Japan Science and Technology Agency), Proposal for Innovation Policy Planning Based on Technological, Economic, and Social Quantitative Scenarios toward the Realization of a Low-Carbon Society, LCS-FY2020-PP-06). The amount of CO₂ captured per unit time by the CO₂ capture device is the product of the number of cycles performed per unit time and the amount of CO₂ captured in a single cycle.
CAPEX: the total of equipment cost, depreciation period, construction cost, and labor cost divided by the total amount of CO₂ captured by the equipment over its lifetime.
OPEX: the operating cost for capturing 1 kg of CO₂, including energy cost and replacement cost for degraded adsorbent.

In the present method, for example, by using a honeycomb adsorber with low pressure loss and increasing the rate of CO₂ adsorption and desorption (i.e., the number of adsorption/desorption cycle switches per unit time) compared with conventional methods, the proportion of capital expenditure (CAPEX) in the CO₂ capture cost can be reduced. As a result, CO₂ can be captured at a lower cost than in conventional methods.

For example, in the present method, CO₂ capture can be performed using a CO₂ capture device that includes the adsorber described below (and the other components shown in FIG. 1).

### Adsorber

An adsorber in which a porous support (a honeycomb substrate coated with silica gel) has its silica-gel portion (120 μm in thickness) impregnated with a CO₂ adsorbent (a polyamine such as polyethyleneimine having an isopropyl group). As the honeycomb substrate, a cordierite substrate having a cell density of 400 cpsi and a wall thickness of 4.5 mil is used, and the loading amount of the coating material (silica gel) is set to 50 g/L to 150 g/L.
Thickness in the direction of the gas flow: 0.1 meters
Pressure loss: 0.0218×(gas velocity (m/s))² (an approximate equation based on the measured data below)

### Measured Data

For a honeycomb substrate with L=0.05 m, a cell density of 400 cpsi, a wall thickness of 4.5 mil, and a silica-gel coating with a loading amount of 100 g/L,
the pressure loss was 1.7 kPa at a gas velocity of 11.8 m/s and 6 kPa at a gas velocity of 23.6 m/s.

### Operating Conditions

Total cycle time of the adsorption and desorption steps: less than 60 minutes (t1=15 minutes, t2<60 minutes)

A typical CO₂ capture method using a CO₂ capture device equipped with the following amine/nanofiber-type adsorber is used for comparison.

### Adsorber

A fibrous filter formed by impregnating the substrate described below, which serves as a support, with the amine described below, which serves as a CO₂ adsorbent.
Amine: N-(2-aminoethyl)-3-aminopropyl-methyldimethoxysilane (AEAPDMS)
Substrate: Nanofibers (fibrillated cellulose suspension)
Thickness in the direction of the gas flow: 1.2 meters
Pressure loss: 5.53 kPa (at a gas velocity of 0.573 m/s)

### Operating Conditions

Adsorption step: room temperature (25° C.), 1 atm, 30 minutes
Desorption step: 90° C., 0.03 atm, 30 minutes
Total cycle time: 60 minutes

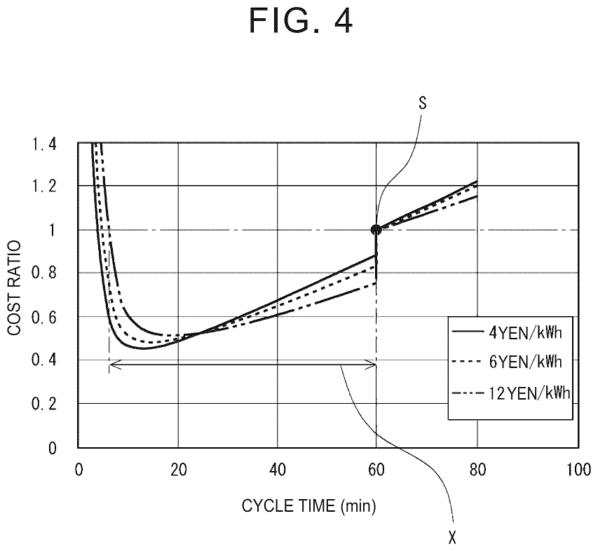

FIG. 4 illustrates the relationship between cycle time (minutes) and cost ratio in the present method and in the above typical CO₂ capture method used for comparison. The graph shows the relative cost ratio, where the cost for the above typical CO₂ capture method is defined as reference S and set to 1. The cost is determined comprehensively based on the CAPEX and OPEX described above. Since electricity prices (yen/kWh) significantly affect CO₂ capture cost, the graph presents three cases in which the electricity price is 4 yen/kWh, 6 yen/kWh, and 12 yen/kWh.

For the CO2 capture cost, the cost ratio relative to reference S was estimated based on the following five assumptions. The results are shown in FIG. 4.
(1) CAPEX is assumed to be constant, and the proportion of CAPEX per kilogram of captured CO₂ decreases as the cycle time becomes shorter, that is, as the amount of CO₂ captured per unit time increases.
(2) The amount of air supplied to the adsorbent per cycle is assumed to be constant.
(3) It is assumed that as the cycle time becomes shorter, the gas velocity increases, and the energy used for blowing increases due to pressure loss, thereby increasing the cost per kilogram of captured CO₂.
(4) The energy used for blowing is assumed to be proportional to the square of the gas velocity.
(5) It is assumed that the CO₂ capture cost reflects a trade-off between (1) and (3).

Referring to the graph, when t2 is less than 60 minutes, the present method using the above CO₂ capture device can achieve lower cost than reference S that corresponds to the typical CO₂ capture method, regardless of the electricity price.

The lower limit of the cycle time that enables cost reduction may be set as appropriate depending on the adsorber used. In the CO₂ capture device shown in FIG. 4, the cost ratio becomes less than 1 when t2 is four minutes or more. Accordingly, the cycle-time range indicated by symbol X represents the range in which cost reduction is achieved compared with the conventional method. FIG. 4 also shows that a further cost reduction can be achieved when the cycle time is, for example, 4 minutes or more and 20 minutes or less.

The present disclosure is not limited to the above embodiment, and may be modified as appropriate without departing from the spirit and scope of the disclosure. The present disclosure contributes to carbon neutrality, decarbonization, and the Sustainable Development Goals (SDGs).

What is claimed is:

1. A CO₂ capture method in which CO₂ contained in a gas that is supplied is adsorbed onto a CO₂ adsorbent body, and the CO₂ adsorbed on the CO₂ adsorbent body is recovered by desorbing the CO₂ from the CO₂ adsorbent body through adjustment of the CO₂ adsorbent body to a temperature higher than a temperature during adsorption of CO₂, adsorption and desorption of CO₂ being alternately repeated,
wherein t1 represents a shortest time for an CO₂ adsorption ratio of the CO₂ adsorbent body to reach 80 vol % or more, t2 represents a cycle time including the adsorption and desorption of CO₂, and t1<t2<4×t1 is satisfied.

2. The CO₂ capture method according to claim 1, wherein:
the CO₂ adsorbent body includes a CO₂ adsorbent and a plurality of porous supports that carries the CO₂ adsorbent; and
the CO₂ adsorbent includes polyethyleneimine having an isopropyl group.

3. The CO₂ capture method according to claim 2, wherein the porous supports have a honeycomb structure.

4. The CO₂ capture method according to claim 1, wherein a rate at which the gas is supplied to the CO₂ adsorbent body is 11 m/s or more.

5. The CO₂ capture method according to claim 2, wherein the porous supports are coated with silica gel, and a thickness of the silica gel is 250 μm or less.
